(19) United States
(12) Patent Application Publication
(10) Pub. No.: US 2022/0056277 A1
(43) Pub. Date: Feb. 24, 2022

(54) HIGHLY ANTISTATIC COATING FLOOR MATERIAL AND COATING FLOOR

(71) Applicant: SUMITOMO RUBBER INDUSTRIES, LTD., Hyogo (JP)

(72) Inventors: KOJI HAJIMA, Hyogo (JP); YOSHIO HIRAYAMA, Hyogo (JP); NORIFUMI SANO, Hyogo (JP)

(73) Assignee: SUMITOMO RUBBER INDUSTRIES, LTD., HYOGO (JP)

(21) Appl. No.: 17/355,138

(22) Filed: Jun. 22, 2021

(30) Foreign Application Priority Data
Aug. 21, 2020 (JP) 2020-139802

(51) Int. Cl. C09D 1/00; E04F 15/18; C09D 5/24; C09D 7/47; C09D 7/40; C09D 163/00; C09D 7/20

(52) U.S. Cl. CPC C09D 1/00; E04F 15/18; C09D 5/24; C09D 7/47; C01B 32/158; C09D 163/00; C09D 7/20; E04F 2290/048; C09D 7/66

(57) ABSTRACT

Achieved is a coating floor material using a carbon nanotube, which has excellent finishing properties and shows high conductivity even when a cured coating film is at 50 V. This coating floor material contains: a room temperature curable resin, a single-walled carbon nanotube, a wetting dispersant, a leveling agent, and a defoaming agent, wherein the wetting dispersant is a polymer salt containing an acidic group and an amino group.

### CROSS-REFERENCE TO RELATED APPLICATION

This application claims the priority benefit of Japan application serial no. 2020-139802, filed on Aug. 21, 2020. The entirety of the above-mentioned patent application is hereby incorporated by reference herein and made a part of this specification.

### BACKGROUND

### Technical Field

The disclosure relates to a coating floor material having improved antistatic performance. The disclosure also relates to a coating floor including a cured coating film of this coating floor material.

### Related Art

For a floor of a production facility or the like such as a factory, a coating floor using a curable resin such as epoxy resin or the like is often used. However, there is a problem that because the curable resin used for the coating floor is electrically insulating, damages due to static electricity occur during work on the coating floor which has been constructed. Therefore, in order to impart antistatic performance to the coating floor, a conductive filler is added to the curable resin. For example, Patent literature 1 describes that conductive titanium oxide powder and a carbon fiber are used as the conductive filler. Patent literature 2 describes that a carbon fiber is used as the conductive filler. Patent literature 3 describes that a conductive metal oxide such as conductive zinc oxide or the like and a stainless fiber are used as the conductive filler.

It is said that a leakage resistance when grounding the static electricity charged on the human body through the coating floor should be about 10⁸ Ω. Therefore, the antistatic coating floor has conductivity in which the resistance is 10⁸ Ω or less when measured at an applied voltage of 500 V.

### [Literature of Related Art]

### [Patent Literature]

[Patent literature 1] Japanese Patent Laid-Open No. 2013-40446

[Patent literature 2] Japanese Patent Laid-Open No. 2017-48333

[Patent literature 3] Japanese Patent Laid-Open No. 2016-223252

### SUMMARY

On one hand, in the production facility or the like, electrostatic damages such as destruction of electronic components at low voltage may also occur. Meanwhile, the coating floor of the prior art has a sea-island structure in which the curable resin is a sea phase and the conductive filler is an island phase. In the sea-island structure, because electricity is applied between the island phases which clamp the sea phase, a voltage above a certain level is required for conductivity. Therefore, the coating floor of the prior art does not show conductivity at a low voltage such as 50 V, and electrostatic damages at this low voltage cannot be prevented. Thus, development of a coating floor that shows conductivity even at a low voltage such as 50 V is desired.

Here, in order to improve the conductivity, it is conceivable to add a large amount of the conductive filler to the conventional coating floor material. However, adding a large amount of the conductive filler causes an increase in viscosity of the coating floor material, and as a result, coating workability is lowered and a finished state of the coating floor is deteriorated. Specifically, sufficient flatness and gloss cannot be obtained, which causes coating film defects such as air bubbles and the like.

On the other hand, a carbon nanotube is known as a material having high conductivity. However, because the carbon nanotube causes an increase in viscosity due to aggregation, the finished state of the coating floor is similarly deteriorated. Therefore, a coating floor material using a carbon nanotube, which has excellent finishing properties, cannot been achieved.

In view of such circumstances, the disclosure achieves a coating floor material using a carbon nanotube, which has excellent finishing properties and shows high conductivity even when a cured coating film is at 50 V.

The disclosure is a coating floor material containing: a room temperature curable resin, a single-walled carbon nanotube, a wetting dispersant, a leveling agent, and a defoaming agent, wherein the wetting dispersant is a polymer salt containing an acidic group and an amino group.

According to the disclosure, a coating floor material using a carbon nanotube can be provided which has excellent finishing properties and shows high conductivity even when a cured coating film is at 50 V.

### DESCRIPTION OF THE EMBODIMENTS

A coating floor material of the disclosure contains a room temperature curable resin, a single-walled carbon nanotube, a wetting dispersant, a leveling agent, and a defoaming agent. This wetting dispersant is a polymer salt containing an acidic group and an amino group.

[Room Temperature Curable Resin]

The room temperature curable resin is a resin that can be cured at room temperature (for example, 0° C. to 40° C., particularly 5° C. to 35° C.), which is a construction environment temperature, and a resin known for applications of the coating floor material can be used therefor. As the room temperature curable resin, a two-component curable resin, a moisture-curable resin, a radically polymerizable resin, or the like can be used, and among these resins, a two-component curable resin is preferable. Specific examples of the room temperature curable resin include an epoxy resin, a urethane resin, an acrylic resin, a polyester resin, a vinyl ester resin, and the like, and among these resins, an epoxy resin is preferable.

As the epoxy resin, a resin known for the applications of the coating floor material can be used, and a two-component curable resin is preferable that shows a liquid state at room temperature and is cured by a reaction with a curing agent.

Examples of the epoxy resin include: an alicyclic epoxy resin such as 3,4-epoxycyclohexylmethyl-3,4-epoxycyclohexanecarboxylate or the like; a glycidyl ester type epoxy resin such as diglycidyl hexahydrophthalate or the like; a bisphenol type epoxy resin derived from epihalohydrins and bisphenol such as bisphenol A, bisphenol F or the like; an epoxidized product of a novolac resin such as a phenol novolac resin, a cresol novolac resin, a bisphenol A novolac resin, a naphthol novolac resin, a biphenyl novolac resin, or the like; a glycidyl ether type epoxy resin derived from epihalohydrins and dihydric alcohol such as hydride bisphenol F, hydride bisphenol A, 1,4-cyclohexanedimethanol, an alkylene oxide adduct of bisphenol A, or the like; an epoxy resin derived from epihalohydrins and polyhydric phenol such as hydroquinone, catechol, or the like; and other resins. Among these resins, a bisphenol type epoxy resin (particularly, a bisphenol A type epoxy resin) is preferable. These resins can be used alone, or two or more types of the resins can be used in combination.

As the curing agent, those known for the applications of the coating floor material can be used. Specific examples thereof include: aliphatic amines such as diethylene triamine, triethylenetetramine, pentaethylene hexamine, and the like, or modified products thereof; aromatic amines such as m-phenylenediamine, m-xylene diamine, diaminodiphenylmethane, and the like, or modified products thereof; alicyclic amines such as 1,3-bis(aminomethyl)cyclohexane, isophoronediamine, and the like, or modified products thereof; acid anhydrides such phthalic anhydride, hexahydrophthalic anhydride, pyromellitic anhydride, and the like; polysulfide; acid amide; thiocol; and the like. Among these curing agents, alicyclic amines, aromatic amines, and modified products thereof are preferable. The modified products may be Mannich modified products, adduct modified products, or the like. These curing agents can be used alone, or two or more types of the curing agents can be used in combination.

With respect to a mixing amount of the epoxy resin and the curing agent, as in the conventional case, a molar amount of the epoxy group contained in the epoxy resin and a molar amount of active hydrogen contained in the curing agent may be set to be substantially equal to each other. Moreover, when a reactive diluent described later is used, a total molar amount of the epoxy group contained in the epoxy resin and the epoxy group contained in the reactive diluent and the molar amount of the active hydrogen contained in the curing agent may be set to be substantially equal each other.

[Single-Walled Carbon Nanotube]

In the disclosure, a single-walled carbon nanotube (SWNT) is used as the conductive filler. The SWNT has a structure in which one graphene sheet is wound in a cylindrical shape. The single-walled carbon nanotube may be any one of armchair type, zigzag type, and chiral type single-walled carbon nanotubes. From the viewpoint of being capable of being easily dispersed in the coating floor material, a single-walled carbon nanotube which is pre-dispersed is preferable to be used, and particularly, a single-walled carbon nanotube which is pre-dispersed in a diluent having reactivity with a room temperature curable resin is preferable to be used. The single-walled carbon nanotube can be synthesized according to a known method and is also available as a commercial product. The pre-dispersed single-walled carbon nanotube is suitably “TUBALL MATRIX 201” manufactured by OCSIAL Ltd. The “TUBALL MATRIX 201” contains a fatty acid glycidyl ester as a reactive diluent. Therefore, when the epoxy resin is used as the room temperature curable resin, the fatty acid glycidyl ester can react with the curing agent together with the epoxy resin.

A content of the single-walled carbon nanotube in the coating floor material is not particularly limited, but if the content is too low, the conductivity may be insufficient. Thus, the content of the single-walled carbon nanotube in the coating floor material (that is, with respect to the total mass of the coating floor material; with respect to the total mass of the coating floor material also including the mass of the curing agent when the room temperature curable resin is a two-component curable resin) is preferably 0.010% by mass or more, more preferably 0.015% by mass or more, and further preferably 0.020% by mass or more. On the other hand, if the content of the single-walled carbon nanotube in the coating floor material is too high, the coating floor material may become thicker and the finishing properties may be impaired. Thus, the content of the single-walled carbon nanotube in the coating floor material is preferably 0.040% by mass or less, more preferably 0.035% by mass or less, and further preferably 0.030% by mass or less.

[Wetting Dispersant]

In the disclosure, the wetting dispersant is used. In the field of paints, the wetting dispersant is an additive which acts as a surfactant and has both a function of a wetting agent that improves the wettability of the coating film and a function of a dispersant that prevents particle aggregation by an action mechanism such as electrical repulsion, steric hindrance, or the like. Besides, in the disclosure, among the wetting dispersants, a wetting dispersant is used which is a polymer salt containing an acidic group and an amino group. By using this wetting dispersant, even when the single-walled carbon nanotube is used, the single-walled carbon nanotube can be prevented from agglomerating in the coating floor material, and the deterioration of the finishing properties due to the thickening can be suppressed.

As the acidic group, an acid phosphate group is preferable. The polymer of the polymer salt may be a homopolymer or a copolymer. The polymer is preferably a graft copolymer in which one or more side chains (for example, polyester chains) are introduced into a main chain (for example, polyurethane chain). At this time, the dispersibility of the single-walled carbon nanotube becomes higher due to the steric hindrance of the polymer chains. As the polymer salt, an alkylammonium salt and a phosphate ester salt are preferable, and an alkylammonium salt is more preferable.

The wetting dispersant preferably has an acid value and an amine value of 10 mgKOH/g or more, respectively. From the viewpoint of storage stability, the acid value and the amine value of the wetting dispersant are more preferably 30 mgKOH/g or more, and further preferably 35 mgKOH/g or more, respectively. Moreover, the acid value represents an acid value per gram of a solid content of the polymer dispersant, and can be obtained by, for example, a potentiometric titration method according to JIS K0070. The amine value represents an amine value per gram of the solid content of the polymer dispersant, and can be obtained by, for example, using a 0.1 N aqueous hydrochloric acid and converting the value obtained by the potentiometric titration method into the equivalent of potassium hydroxide.

The wetting dispersant that can be used in the disclosure may be “BYK-9076” and “DISPERBYK-142” manufactured by BYK-Chemie Japan; “Disparlon DA-325” manufactured by Kusumoto Chemicals, Ltd.; or the like, and “BYK-9076” and “DISPERBYK-142” are preferable. These wetting dispersants can be used alone, or two or more types of the wetting dispersants can be used in combination.

A content of the wetting dispersant in the coating floor material is not particularly limited, but if the content is too low, sufficient conductivity may not be obtained. In addition, the higher the content of the wetting dispersant, the higher the storage stability tends to be. Thus, the content of the wetting dispersant in the coating floor material is preferably 0.04% by mass or more, more preferably 0.10% by mass or more, and further preferably 0.15% by mass or more. On the other hand, if the content of the wetting dispersant in the coating floor material is too high, the conductivity may decrease. Thus, the content of the wetting dispersant in the coating floor material is preferably 0.40% by mass or less, more preferably 0.32% by mass or less, and further preferably 0.25% by mass or less.

[Leveling Agent]

In the disclosure, the leveling agent is used. The finishing properties can be improved by using the leveling agent. A known leveling agent used for the coating floor material may be used as the leveling agent. The leveling agent may be an acrylic polymer or the like. As the leveling agent, the “Polyflow” series manufactured by Kyoeisha Chemical Co., Ltd. may be used. These leveling agents can be used alone, or two or more types of the leveling agents can be used in combination.

A content of the leveling agent in the coating floor material is not particularly limited, but if the content is too low, the finishing properties may decrease. Thus, the content of the leveling agent in the coating floor material is preferably 0.04% by mass or more, more preferably 0.06% by mass or more, and further preferably 0.07% by mass or more. On the other hand, if the content of the leveling agent in the coating floor material is too high, the conductivity may be insufficient. Thus, the content of the leveling agent in the coating floor material is preferably 0.21% by mass or less, more preferably 0.18% by mass or less, and further preferably 0.15% by mass or less.

### [Defoaming Agent]

In the disclosure, the defoaming agent is used. The finishing properties can be improved by using the defoaming agent. A known defoaming agent used for the coating floor material may be used as the defoaming agent. The defoaming agent may be an acrylic polymer, a vinyl ether polymer, a mixture thereof, or the like. As the defoaming agent, the “Flowlen” series manufactured by Kyoeisha Chemical Co., Ltd. may be used. These defoaming agents can be used alone, or two or more types of the defoaming agents can be used in combination.

A content of the defoaming agent in the coating floor material is not particularly limited, but if the content is too low, the finishing properties may decrease. Thus, the content of the defoaming agent in the coating floor material is preferably 0.12% by mass or more, more preferably 0.18% by mass or more, and further preferably 0.24% by mass or more. On the other hand, if the content of the defoaming agent in the coating floor material is too high, the conductivity may be insufficient. Thus, the content of the defoaming agent in the coating floor material is preferably 0.40% by mass or less, more preferably 0.38% by mass or less, and further preferably 0.36% by mass or less.

The coating floor material of the disclosure may contain a pigment for the purpose of adjusting a color tone and the like. As the pigment, a known pigment used for the coating floor material may be used. A content of the pigment may be appropriately set according to a type of the pigment, a desired color tone, and the like.

The coating floor material of the disclosure may contain an insulating filler for the purpose of improving strength, improving coloring properties, and the like. As the insulating filler, a known insulating filler used for the coating floor material may be used. Examples thereof include calcium carbonate, magnesium carbonate, barium sulfate, calcium oxide, magnesium oxide, alumina, silica, kaolin, talc, mica, glass beads, glass micro-balloons, glass fibers, and the like. Among these examples, calcium carbonate (particularly, heavy calcium carbonate) is preferable. A content of the insulating filler may be appropriately set according to a desired strength and the like.

The coating floor material of the disclosure may contain a reactive diluent, a non-reactive diluent, and the like for the purpose of adjusting the viscosity and the like. The reactive diluent may be, for example, a compound having one or more reactive groups of the same type as the room temperature curable resin. Specifically, for example, when the room temperature curable resin is the epoxy resin, a compound having an epoxy group such as neopentyl glycol diglycidyl ether or the like can be used. The non-reactive diluent may be, for example, a compound that does not have the same type of reactive group as the room temperature curable resin. Specifically, for example, when the room temperature curable resin is the epoxy resin, benzyl alcohol or the like can be used. Contents of the reactive diluent and the non-reactive diluent may be appropriately set according to the desired viscosity and the like.

The coating floor material of the disclosure may further contain components other than the above components as long as the effects of the disclosure are not significantly impaired.

A method for preparing the coating floor material of the disclosure is not particularly limited, and the coating floor material can be prepared according to a known method. For example, each component of the coating floor material of the disclosure may be blended and prepared at one time at a construction site or the like. For example, the coating floor material of the disclosure is a two-component type divided into the curing agent and a main agent containing a component other than the curing agent, and may be prepared as a type used by mixing the main agent and the curing agent at the construction site or the like. For example, when the two-component coating floor material is prepared, a main agent component in which the insulating filler is not blended or a small amount of the insulating filler is blended may be prepared. For example, at the construction site or the like, the insulating filler may be added to the main agent in order to obtain a blending amount obtained in consideration of a situation of groundwork, characteristics required for the coating floor, or the like. For example, when the two-component type is prepared, a main agent component in which a colorant is not blended may be prepared. For example, at the construction site or the like, the colorant may be added to the main agent according to the color tone required for the coating floor.

The coating floor material of the disclosure can be constructed and used according to a known method. For example, a coating floor can be formed in a way that the coating floor material of the disclosure is coated by a casting method on the floor to be constructed, and then left for a predetermined time to dry and cure the epoxy resin. The coating floor to be constructed may have a single-layer structure of a layer formed by the coating floor material of the disclosure (that is, a layer of a cured coating film of the coating floor material of the disclosure), or a multi-layer structure in which the layer formed by the coating floor material of the disclosure and a primer layer are combined.

According to the coating floor material of the disclosure, the coating floor which has sufficient flatness and gloss even though carbon nanotube is used can be obtained by using the wetting dispersant and further combining the wetting dispersant with the leveling agent and the defoaming agent. In addition, in the coating floor material of the disclosure, occurrence of coating film defects such as air bubbles and the like is suppressed. Therefore, the coating floor material of the disclosure is excellent in finishing properties. In addition, according to the coating floor material of the disclosure, the cured coating film thereof shows high conductivity even at 50 V. Specifically, it is also possible to achieve a conductivity in which a resistance at 50 V is less than 10⁹ Ω, furthermore 10⁷ Ω or less, and particularly 10⁶ Ω or less. Furthermore, the cured coating film can show high conductivity even at 25 V. Thus, the coating floor material of the disclosure has much higher antistatic performance than the conventional coating floor material (thus, the coating floor material of the disclosure can be referred to as a “highly antistatic coating floor material”), and can prevent not only conventional antistatic but also electrostatic damages such as destruction of electronic components at low voltage.

Therefore, from another viewpoint, the disclosure is a coating floor including a cured coating film of the aforementioned coating floor material. This coating floor may have a primer layer. A thickness of the cured coating film of the aforementioned coating floor material is not particularly limited, and is 1.0 mm or more and 3.0 mm or less for example, and preferably 1.0 mm or more and 2.0 mm or less. The coating floor of the disclosure has a good finished state and shows high conductivity even at 50 V. Thus, electrostatic damages such as destruction of electronic components at low voltage is prevented. The coating floor of the disclosure can be used in various buildings, and is particularly suitable for research facilities and production facilities for electronic components.

### EXAMPLE 1

Hereinafter, examples relating to the disclosure are described, but the disclosure is not intended to be limited to those shown in these examples.

### EXAMPLES AND COMPARATIVE EXAMPLES

Each component shown in Tables 1 and 2 was mixed to prepare a two-component coating floor material composed of a main agent and a curing agent. Moreover, values in the tables indicate parts by mass. The total of the main agent and the curing agent is about 120 parts by mass.

[Evaluation of Conductivity]

Coating floor materials of each example and each comparative example were coated on a flat plate on which a primer layer and a conductive primer layer (resistance: about 10³ Ω) were formed, and the epoxy resin was cured to prepare a test sample. With respect to this test sample, resistance was measured when an applied voltage was 500 V, 100 V, 50 V, and 25 V by using an insulation resistance tester according to the NFPA method and JIS A1454: 2016. Moreover, a 2.25 kg iron cylinder was used as electrodes, and a distance between the electrodes was set to 3 feet (about 91 cm). The measurement results are shown in Tables 1 and 2.

[Evaluation of Finished State]

The coating floor materials of each example and each comparative example was coated with a thickness of 1.0 mm on the flat plate on which the primer layer was formed, and the epoxy resin was cured to prepare a test sample. A surface of the test sample was exposed to fluorescent light to check for the presence or absence of reflection unevenness. In addition, the presence or absence of air bubbles and air bubble traces was checked. Evaluation was made according to the following criteria, and a score of o or higher was considered acceptable. The results are shown in Tables 1 and 2.

⊚: There is almost no reflection unevenness, and there are no air bubble or air bubble traces either.

∘: Slight reflection unevenness is seen, but no air bubble and air bubble traces are seen.

Δ: Reflection unevenness is seen, and air bubbles and air bubble traces are also slightly seen.

×: Reflection unevenness is conspicuous, and many air bubbles and air bubble traces are seen.

[Evaluation of Storage Stability]

After the coating floor materials of each example and each comparative example were prepared, the coating floor materials were left at room temperature for one month. Thereby, the resistance was measured by the same method as above with an applied voltage of 50 V, and evaluated according to the following criteria. The results are shown in Tables 1 and 2.

∘: Resistance value is less than 10⁶

Δ: Resistance value is 10⁶ Ω or more and less than 10⁸ Ω

×: Resistance value is 10⁸ Ω or more

TABLE 1

| | | | Example | Example | Example | Example | Example |
|---|---|---|---|---|---|---|---|
| | | | 1 | 2 | 3 | 4 | 5 |
| Main | Epoxy | Bisphenol | 46.4 | 46.4 | 46.4 | 46.4 | 46.4 |
| agent | resin | A type | | | | | |
| | | epoxy | | | | | |
| | | resin | | | | | |
| | Reactive | Neopentyl | 5.3 | 5.3 | 5.3 | 5.3 | 5.3 |
| | diluent | glycol | | | | | |
| | | diglycidyl | | | | | |
| | | ether | | | | | |
| | Non- | Benzyl | 5.1 | 5.2 | 5.0 | 5.2 | 4.8 |
| | reactive | alcohol | | | | | |
| | diluent | | | | | | |
| | Calcium | Heavy | 39.7 | 39.7 | 39.7 | 39.7 | 39.7 |
| | carbonate | calcium | | | | | |
| | | carbonate | | | | | |
| | Leveling | Polyflow | 0.1 | 0.1 | 0.1 | 0.1 | 0.1 |
| | agent | #85 | | | | | |
| | Defoaming | Flowlen | 0.4 | 0.4 | 0.4 | 0.4 | 0.4 |
| | agent | AC324 | | | | | |
| | Pigment | Pigment | 2.5 | 2.5 | 2.5 | 2.5 | 2.5 |
| | | mixed | | | | | |
| | | coloring | | | | | |
| | | toner | | | | | |
| | Carbon | MATRIX201 | 0.3 | 0.2 | 0.4 | 0.3 | 0.3 |
| | nanotube | (Carbon | (0.03) | (0.02) | (0.04) | (0.03) | (0.03) |
| | dispersion | nanotube) | | | | | |
| | | (Reactive | (0.27) | (0.18) | (0.36) | (0.27) | (0.27) |
| | | diluent) | | | | | |
| | Conductive | 23K-P | | | | | |
| | zinc oxide | | | | | | |
| | Metal fiber | Naslon | | | | | |
| | Carbon | Besfight | | | | | |
| | fiber | Chop | | | | | |
| | Wetting | BYK-9076 | 0.2 | 0.2 | 0.2 | | |
| | dispersant | DISPERBYK- | | | | 0.2 | |
| | | 142 | | | | | |
| | | DA-325 | | | | | 0.2 |
| | | BYK-9077 | | | | | |
| | | DISPERBYK- | | | | | |
| | | 2152 | | | | | |
| Curing | Amine- | Modified | 20.0 | 20.0 | 20.0 | 20.0 | 20.0 |
| agent | based | polyamine | | | | | |
| | curing | | | | | | |
| | agent | | | | | | |
| Conductivity | | 500 V (Ω) | 1.1 × 10⁵ | 1.8 × 10⁶ | 8.9 × 10⁴ | 1.5 × 10⁵ | 2.2 × 10⁵ |
| | | 100 V (Ω) | 1.2 × 10⁵ | 2.6 × 10⁶ | 1.1 × 10⁵ | 2.0 × 10⁵ | 2.5 × 10⁵ |
| | | 50 V (Ω) | 1.5 × 10⁵ | 6.8 × 10⁶ | 1.2 × 10⁵ | 2.8 × 10⁵ | 3.3 × 10⁵ |
| | | 25 V (Ω) | 1.5 × 10⁵ | 7.2 × 10⁶ | 1.5 × 10⁵ | 4.8 × 10⁵ | 3.3 × 10⁵ |
| Finished state | | | ⊚ | ⊚ | ◯ | ⊚ | ⊚ |
| Storage stability | | | ◯ | — | — | ◯ | X |
| | | | | Comparative | Comparative | Comparative | Comparative |
| | | | | Example 1 | Example 2 | Example 3 | Example 4 |
| | Main | Epoxy | Bisphenol | 46.4 | 46.4 | 46.4 | 54.2 |
| | agent | resin | A type | | | | |
| | | | epoxy | | | | |
| | | | resin | | | | |
| | | Reactive | Neopentyl | 5.3 | 5.3 | 5.3 | 4.8 |
| | | diluent | glycol | | | | |
| | | | diglycidyl | | | | |
| | | | ether | | | | |
| | | Non- | Benzyl | 5.1 | 5.1 | 5.2 | 8.5 |
| | | reactive | alcohol | | | | |
| | | diluent | | | | | |
| | | Calcium | Heavy | 39.7 | 39.7 | 39.7 | 13.2 |
| | | carbonate | calcium | | | | |
| | | | carbonate | | | | |
| | | Leveling | Polyflow | 0.1 | 0.1 | 0.1 | 0.6 |
| | | agent | #85 | | | | |
| | | Defoaming | Flowlen | 0.4 | 0.4 | 0.4 | 0.3 |
| | | agent | AC324 | | | | |
| | | Pigment | Pigment | 2.5 | 2.5 | 2.5 | 4.8 |
| | | | mixed | | | | |
| | | | coloring | | | | |
| | | | toner | | | | |
| | | Carbon | MATRIX201 | 0.3 | 0.3 | 0.3 | |
| | | nanotube | (Carbon | (0.03) | (0.03) | (0.03) | |
| | | dispersion | nanotube) | | | | |
| | | | (Reactive | (0.27) | (0.27) | (0.27) | |
| | | | diluent) | | | | |
| | | Conductive | 23K-P | | | | 12.6 |
| | | zinc oxide | | | | | |
| | | Metal fiber | Naslon | | | | 0.7 |
| | | Carbon | Besfight | | | | 0.2 |
| | | fiber | Chop | | | | |
| | | Wetting | BYK-9076 | | | | |
| | | dispersant | DISPERBYK- | | | | |
| | | | 142 | | | | |
| | | | DA-325 | | | | |
| | | | BYK-9077 | | 0.2 | | |
| | | | DISPERBYK- | | | 0.2 | |
| | | | 2152 | | | | |
| | Curing | Amine- | Modified | 20.0 | 20.0 | 20.0 | 25.0 |
| | agent | based | polyamine | | | | |
| | | curing | | | | | |
| | | agent | | | | | |
| | Conductivity | | 500 V (Ω) | 3.0 × 10⁶ | 1.8 × 10⁵ | 4.7 × 10⁵ | 4.5 × 10⁵ |
| | | | 100 V (Ω) | 1.2 × 10⁸ | 2.5 × 10⁵ | 9.2 × 10⁵ | 2.6 × 10⁶ |
| | | | 50 V (Ω) | 10⁹ or more | 3.0 × 10⁵ | 1.8 × 10⁶ | 10⁹ or more |
| | | | 25 V (Ω) | 10⁹ or more | 3.2 × 10⁵ | 5.3 × 10⁶ | 10⁹ or more |

| | | | | |
|---|---|---|---|---|
| Finished state | ⊚ | X | Δ | ⊚ |
| Storage stability | — | — | X | — |

TABLE 2

| | | | Example | Example | Example | Example | Example | Example | Example |
|---|---|---|---|---|---|---|---|---|---|
| | | | 6 | 7 | 8 | 9 | 10 | 11 | 12 |
| Main | Epoxy | Bisphenol | 46.4 | 46.4 | 46.4 | 46.4 | 46.4 | 46.4 | 46.4 |
| agent | resin | A type | | | | | | | |
| | | epoxy | | | | | | | |
| | | resin | | | | | | | |
| | Reactive | Neopentyl | 5.3 | 5.3 | 5.3 | 5.3 | 5.3 | 5.3 | 5.3 |
| | diluent | glycol | | | | | | | |
| | | diglycidyl | | | | | | | |
| | | ether | | | | | | | |
| | Non- | Benzyl | 5.2 | 5.2 | 5.0 | 4.8 | 5.2 | 5.0 | 5.2 |
| | reactive | alcohol | | | | | | | |
| | diluent | | | | | | | | |
| | Calcium | Heavy | 39.7 | 39.7 | 39.7 | 39.7 | 39.7 | 39.7 | 39.7 |
| | carbonate | calcium | | | | | | | |
| | | carbonate | | | | | | | |
| | Leveling | Polyflow | 0.1 | 0.1 | 0.1 | 0.1 | 0.06 | 0.18 | 0.1 |
| | agent | #85 | | | | | | | |
| | Defoaming | Flowlen | 0.4 | 0.4 | 0.4 | 0.4 | 0.4 | 0.4 | 0.2 |
| | agent | AC324 | | | | | | | |
| | Pigment | Pigment | 2.5 | 2.5 | 2.5 | 2.5 | 2.5 | 2.5 | 2.5 |
| | | mixed | | | | | | | |
| | | coloring | | | | | | | |
| | | toner | | | | | | | |
| | Carbon | MATRIX201 | 0.3 | 0.3 | 0.3 | 0.3 | 0.3 | 0.3 | 0.3 |
| | nanotube | (Carbon | (0.03) | (0.03) | (0.03) | (0.03) | (0.03) | (0.03) | (0.03) |
| | dispersion | nanotube) | | | | | | | |
| | | (Reactive | (0.27) | (0.27) | (0.27) | (0.27) | (0.27) | (0.27) | (0.27) |
| | | diluent) | | | | | | | |
| | Wetting | BYK-9076 | 0.05 | 0.12 | 0.24 | 0.30 | 0.2 | 0.2 | 0.2 |
| | dispersant | | | | | | | | |
| Curing | Amine- | Modified | 20.0 | 20.0 | 20.0 | 20.0 | 20.0 | 20.0 | 20.0 |
| agent | based | polyamine | | | | | | | |
| | curing | | | | | | | | |
| | agent | | | | | | | | |
| Conductivity | | 500 V (Ω) | 1.2 × 10⁶ | 2.0 × 10⁵ | 1.2 × 10⁵ | 1.1 × 10⁵ | 8.6 × 10⁴ | 5.2 × 10⁵ | 1.0 × 10⁵ |
| | | 100 V (Ω) | 4.3 × 10⁶ | 2.5 × 10⁵ | 1.2 × 10⁵ | 1.2 × 10⁵ | 1.0 × 10⁵ | 8.7 × 10⁵ | 1.2 × 10⁵ |
| | | 50 V (Ω) | 2.5 × 10⁸ | 7.8 × 10⁵ | 1.7 × 10⁵ | 1.6 × 10⁵ | 1.3 × 10⁵ | 4.5 × 10⁶ | 1.3 × 10⁵ |
| | | 25 V (Ω) | 10⁹ or | 4.4 × 10⁶ | 1.7 × 10⁵ | 1.8 × 10⁵ | 1.5 × 10⁵ | 6.8 × 10⁶ | 1.3 × 10⁵ |
| | | | more | | | | | | |

| | | | | | | | |
|---|---|---|---|---|---|---|---|
| Finished state | ⊚ | ⊚ | ⊚ | ⊚ | ◯ | ⊚ | ◯ |
| Storage stability | X | Δ | ◯ | ◯ | — | — | — |

Polyflow #85: leveling agent “Polyflow #85” manufactured by Kyoeisha Chemical Co., Ltd.

Flowlen AC324: defoaming agent “Flowlen AC324” manufactured by Kyoeisha Chemical Co., Ltd.

MATRIX201: “TUBALL MATRIX201” manufactured by OCSIAL Ltd. (contained by a mass ratio of single-walled carbon nanotube : fatty acid glycidyl ester (reactive diluent) =1:9) BYK-9076: wetting dispersant “BYK-9076” manufactured by BYK-Chemie Japan (alkylammonium salt of polymer with polyester chain grafted on polyurethane main chain; acid value=38 mgKOH/g, amine value =44 mgKOH/g)

DISPERBYK-142: wetting dispersant “DISPERBYK-142” manufactured by BYK-Chemie Japan (phosphate ester salt of high molecular weight copolymer having pigment affinity group; acid value=46 mgKOH/g, amine value=43 mgKOH/g) DA-325: wetting dispersant “Disparlon DA-325” manufactured by Kusumoto Chemicals, Ltd. (mixture of polyether phosphate ester and polyamine; acid value=14 mgKOH/g, amine value=20 mgKOH/g)

BYK-9077: wetting dispersant “BYK-9077” manufactured by BYK-Chemie Japan (high molecular weight copolymer having pigment affinity group; amine value=44 mgKOH/g) DISPERBYK-2152: wetting dispersant “DISPERBYK-2152” manufactured by BYK-Chemie Japan (hyperbranched polyester)

Based on the above results, it can be seen that when the coating floor material contains the room temperature curable resin, the single-walled carbon nanotube, the wetting dispersant, the leveling agent, and the defoaming agent, and the wetting dispersant is the polymer salt containing the acidic group and the amino group, the conductivity is high even at a low voltage of 50 V, and a good finished state can be obtained. Therefore, it can be seen that the coating floor material of the disclosure is excellent in finishing properties even though carbon nanotube is used, and the cured coating film thereof shows high conductivity even at 50 V.

What is claimed is:

1. A coating floor material, containing
a room temperature curable resin, a single-walled carbon nanotube, a wetting dispersant, a leveling agent, and a defoaming agent, wherein
the wetting dispersant is a polymer salt containing an acidic group and an amino group.

2. The coating floor material according to claim 1, wherein a content of the single-walled carbon nanotube is 0.010% by mass or more and 0.040% by mass or less.

3. The coating floor material according to claim 1, wherein a content of the wetting dispersant is 0.04% by mass or more and 0.40% by mass or less.

4. The coating floor material according to claim 1, wherein the wetting dispersant is an alkylammonium salt or a phosphate ester salt.

5. The coating floor material according to claim 1, wherein an acid value and an amine value of the wetting dispersant are respectively 30 mgKOH/g or more.

6. The coating floor material according to claim 1, wherein a content of the leveling agent is 0.04% by mass or more and 0.20% by mass or less.

7. The coating floor material according to claim 1, wherein a content of the defoaming agent is 0.12% by mass or more and 0.40% by mass or less.

8. A coating floor, comprising a cured coating film of the coating floor material according to claim 1.
